(19) United States
(12) Patent Application Publication
(10) Pub. No.: US 2005/0238837 A1
(43) Pub. Date: Oct. 27, 2005

(54) Optical recording medium

(76) Inventors: Junichi Satou, Tokyo (JP); Mamoru Usami, Tokyo (JP); Yoshimi Sakai, Tokyo (JP)

Correspondence Address: YOUNG LAW FIRM;A PROFESSIONAL CORPORATION, 4370 ALPINE ROAD SUITE 106, PORTOLA VALLEY, CA, 94028, US

(21) Appl. No.: 10/832,802

(22) Filed: Apr. 26, 2004

(51) Int. Cl. B32B 3/02

(52) U.S. Cl. 428/64.4

(57) ABSTRACT

An optical recording medium of the present invention includes a support substrate, a functional layer for storing data, and a transparent ink-receiving layer provided opposite to the functional layer with respect to the support substrate, wherein the support substrate has a brightness of 8 or more, and a chroma of 4 or less. Therefore, a colored layer of white ink need not be provided between the ink-receiving layer and the support substrate, thereby simplifying the manufacturing process. Also, the surface quality of the support substrate is reflected in the ink-receiving layer. For example, when the support substrate is formed by injection, therefore, the average surface roughness (Ra) of the ink-receiving layer is significantly decreased. Thus, printing by an ink jet printer can achieve a color and brilliance close to those of a silver salt photograph.

### TECHNICAL FIELD

The present invention relates to an optical recording medium, and particularly to an optical recording medium permitting printing on a label surface opposite to a light incidence surface.

### BACKGROUND ART

In recent years, optical recording media such as CDs (Compact Disc) and DVDs (Digital Versatile Disc) have been widely used as recording media for recording large volumes of digital data. In particular, optical recording media capable of data recording by users have been rapidly popularized. The use of recordable optical recording media enables the simple and inexpensive storage of digital data of large file size, such as picture data and music data. Therefore, the recordable recording media are used by many users. The popularization of such types of optical recording media has increased the demand for manufacture of an original optical recording medium in which a print is provided on a surface (referred to as a “label surface” hereinafter) opposite to a light incidence surface by a printer. Optical recording media capable of realizing the manufacture of original recording media have already been developed and sold.

Such optical recording media include ink-receiving layers provided on the label surfaces, for fixing ink. The ink-receiving layers can be supplied with ink by an ink-jet printer to provide a print on the label surfaces.

However, printability of optical recording media is generally lower than that of glossy paper. There is thus the problem of failing to sufficiently utilize the performance of an ink jet printer capable of high-quality printing. In order to solve this problem, Japanese Unexamined Patent Application Publication No. 2002-237103 proposes an optical recording medium comprising an ink-receiving layer having surface roughness decreased to a predetermined value or less.

In order to decrease the surface roughness of the ink-receiving layer, it is thought to be desirable for the ink-receiving layer to be formed by a spin coating method. In this case, the surface roughness of the ink-receiving layer is influenced by an underlying layer. Even if a coating solution for achieving a smooth surface is selected, the surface roughness of the formed ink-receiving layer is not necessarily decreased. There is thus the problem of failing to achieve high printability.

When the ink-receiving layer is formed by the spin coating method as described above, it is not necessarily easy to decrease the surface roughness.

Japanese Unexamined Patent Application Publication No. 9-288847 discloses a DVD-type optical recording medium including a colored dummy substrate.

### SUMMARY OF THE INVENTION

Accordingly, an object of the present invention is to provide an optical recording medium in which the surface roughness of an ink-receiving layer is securely decreased to permit high-quality printing on the ink-receiving layer.

An optical recording medium of the present invention comprises a support substrate, a functional layer capable of storing data, and a transparent ink-receiving layer provided opposite to the functional layer with respect to the support substrate, wherein the support substrate has a brightness of 8 or more, and a chroma of 4 or less. In the present invention, the support substrate means a substrate different from a substrate or a layer functioning as an optical path of a laser beam applied in data recording and/or reproduction, and having a thickness sufficient for securing the mechanical strength of the optical recording medium. Therefore, the support substrate corresponds to a so-called “dummy substrate” in a DVD and a so-called “support substrate” in a next-generation optical recording medium. The term “transparent ink-receiving layer” means that the support substrate can be seen through the ink-receiving layer.

In the present invention, the support substrate has a brightness of 8 or more, and a chroma of 4 or less, and thus the support substrate is of a white color or a bright color close to white, thereby removing the need to interpose a colored layer of white ink between the ink-receiving layer and the support substrate. Consequently, the manufacturing process is simplified. Also, the surface property of the support substrate is reflected in the ink-receiving layer, and thus the average surface roughness (Ra) of the ink-receiving layer is significantly decreased, for example, when the support substrate is formed by injection. Therefore, printing by the ink jet printer can produce a color and brilliance close to those of silver salt photographs.

Examples of colors having a brightness of 8 or more and a chroma of 4 or less include white (hue: N, brightness: 9.5, chroma 0 (designated by the Munsell system, this designation applying to the description below)), snow white (hue: N, brightness: 9.5, chroma: 0), baby pink (hue: 4R, brightness, 8.5, chroma: 4.0), shell pink (hue: 10R, brightness: 8.5, chroma: 3.5), nail pink (hue: 10R, brightness: 8.0, chroma: 4.0), peach (hue: 3YR, brightness: 8.0, chroma: 3.5), ecru beige (hue: 7.5YR, brightness: 8.5, chroma: 4.0), leghorn (hue: 2.5Y, brightness: 8.0, chroma; 4.0), cream yellow (hue: 5Y, brightness: 8.5, chroma: 3.5), ivory (hue: 2.5Y, brightness: 8.5, chroma: 1.5), cool white (hue: 10PB, brightness: 9.5, chroma: 0.5), and cherry blossom (hue: 10RP, brightness: 9.0, chroma: 2.5).

In the present invention, the support substrate preferably has a brightness of 9 or more and a chroma of 3 or less. The support substrate having a brightness of 9 or more and a chroma of 3 or less can achieve high printability. Examples of colors having a brightness of 9 or more and a chroma of 3 or less include white (hue: N, brightness: 9.5, chroma 0), snow white (hue: N, brightness: 9.5, chroma: 0), cool white (hue: 10PB, brightness: 9.5, chroma: 0.5), and cherry blossom (hue: 10RP, brightness: 9.0, chroma: 2.5).

In the present invention, the support substrate more preferably has a brightness of 9.2 or more and a chroma of 0.5 or less. The support substrate having a brightness of 9.2 or more and a chroma of 0.5 or less can achieve higher printability. Examples of colors having a brightness of 9.2 or more and a chroma of 0.5 or less include white (hue: N, brightness: 9.5, chroma 0), snow white (hue: N, brightness: 9.5, chroma: 0), and cool white (hue: 10PB, brightness: 9.5, chroma: 0.5).

In the present invention, the ink-receiving layer preferably has an average surface roughness (Ra) of 0.1 μm or less. The ink-receiving layer is preferably formed on the surface of the support substrate. The support substrate preferably has an average surface roughness (Ra) of 0.1 μm or less. When the ink-receiving layer is formed on the surface of the support substrate, the excellent surface quality of the support substrate, for example, the surface quality of an average roughness of 0.1 μm or less, can be securely reflected in the ink-receiving layer.

The optical recording medium of the present invention preferably further comprises a light-transmissive substrate provided opposite to the support substrate side with respect to the functional layer and having a thickness substantially the same as that of the support substrate. The optical-recording medium having the above-described structure is a so-called DVD-type optical recording medium.

The optical recording medium of the present invention preferably further comprises a light-transmissive layer provided opposite to the support substrate with respect to the functional layer and having a thickness smaller than that of the support substrate. The optical recording medium having the above-described structure is a so-called next-generation optical recording medium.

The functional layer preferably includes a recording layer. This optical recording medium enables the user to record data, and thus effectively exhibits the characteristics of the optical recording medium of the present invention in that a high-quality print can be provided on the label surface. In this case, like in a recordable optical recording medium, the recording layer may contain an organic dye or an inorganic material. Alternatively, like in a rewritable optical recording medium, the recording layer may contain a phase change material.

In the present invention, a colored layer of white ink need not be provided between the ink-receiving layer and the support substrate, thereby simplifying the manufacturing process. Furthermore, the average surface roughness (Ra) of the ink-receiving layer can be significantly decreased. Therefore, in printing by an ink jet printer, a color and brilliance close to those of a silver salt photograph can be obtained.

### BRIEF DESCRIPTION OF THE DRAWINGS

FIG. 1 is a sectional view schematically showing the structure of an optical recording medium according to a preferred embodiment of the present invention.

FIG. 2 is a schematic sectional view showing the structure of a functional layer in a ROM disk.

FIG. 3 is schematic sectional view showing the structure of a functional layer in a recordable disk.

FIG. 4 is a schematic sectional view showing the structure of a functional layer in a rewritable disk.

FIG. 5 is a sectional view schematically showing the structure of an optical recording medium according to another preferred embodiment of the present invention.

### BEST MODE FOR CARRYING OUT THE INVENTION

Preferred embodiments of the present invention will be described in detail below with reference to the attached drawings.

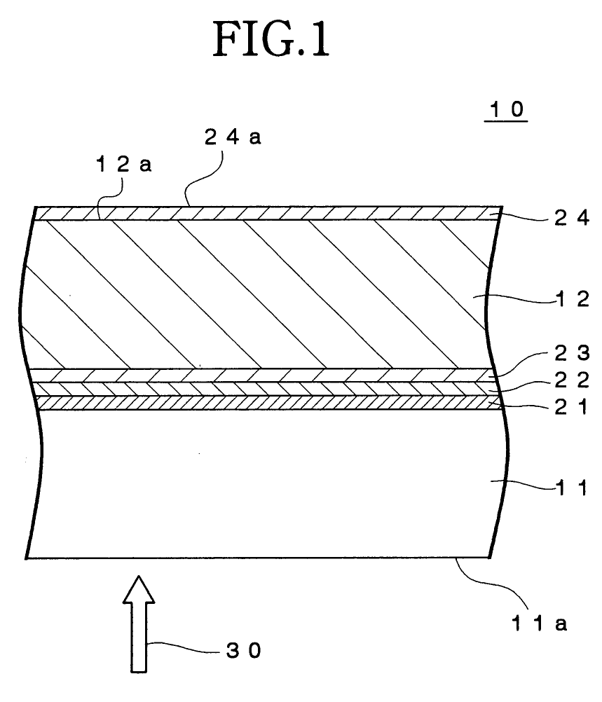

FIG. 1 is a sectional view schematically showing the structure of an optical recording medium according to a preferred embodiment of the present invention. This embodiment relates to the application of the present invention to a DVD-type optical recording medium.

An optical recording medium 10 of this embodiment is a disk-shaped optical recording medium having a diameter of about 120 mm and a thickness of about 1.2 mm. As shown in FIG. 1, the optical recording medium 10 comprises a light-transmissive substrate 11, a dummy substrate (support substrate) 12, a functional layer 21, a protective layer 22, and an adhesive layer 23, which are provided between the two substrates 11 and 12, and an ink-receiving layer 24 provided on the surface of the dummy substrate 12. Data recording and/or reproduction can be performed by applying a laser beam 30 to a light incidence surface 11a while rotating the optical recording medium 10. Although not particularly limited, the wavelength of the laser beam 30 is set to about 650 nm. The numerical aperture of an objective lens for converging the laser beam 30 is set to about 0.65.

The light-transmissive substrate 11 is a disk-shaped substrate comprising a material having sufficiently high transmittance in the wavelength region of the laser beam 30. The surface of the light-transmissive substrate 11 functions as the light incidence surface 11a on which the laser beam 30 is incident. The light-transmissive substrate 11 functions as the optical path of the laser beam 30 applied during data recording and/or reproduction. The light-transmissive substrate 11 also functions as a substrate for securing mechanical strength required for the optical recording medium 10. Although not particularly limited, the thickness of the light-transmissive substrate 11 is set to about 0.6 mm. As a material for the light-transmissive substrate 11, a resin is preferably used from the viewpoint of ease of formation, Examples of the resin used for the light-transmissive substrate 11 include a polycarbonate resin, an olefin resin, an acrylic resin, an epoxy resin, a polystyrene resin, a polyethylene resin, a polypropylene resin, a silicone resin, a fluorocarbon resin, an ABS resin, and a urethane resin. Among these resins, a polycarbonate resin or an olefin resin is preferably used because it has excellent optical properties and processability.

The dummy substrate 12 is the “support substrate” for securing the mechanical strength of the optical recording medium 10. The dummy substrate 12 also functions to secure the thickness (for example, about 1.2 mm) required for the optical recording medium 10. The dummy substrate 12 includes the ink-receiving layer 24 provided on its surface 12a. Although not particularly limited, the thickness of the dummy substrate 12 is set to about 0.6 mm, equivalent to that of the light-transmissive substrate 11. In this embodiment, the same resin as descried above as the preferred material for the light-transmissive substrate 11 is used as a material for the dummy substrate 12. The dummy substrate 12 is also colored white (hue: N, brightness: 9.5, chroma: 0) by adding a white pigment. Preferred examples of the white pigment include titanium oxide, zinc oxide, aluminum oxide, aluminum hydroxide, white lead (basic lead carbonate), strontium titanate, calcium carbonate, mica, barium sulfate, silica, talc, kaoline clay, pyrophyllite clay, and zeolite. In particular, titanium oxide is most preferably selected because it has a high refractive index and can generate color even when used in a small amount. When titanium oxide is used as the white pigment, the added amount is preferably about 5 wt % to 15 wt %. In addition, another color pigment, organic pigment or dye may be combined for controlling the shade of white.

The dummy substrate 12 also functions as an underlying layer of the ink-receiving layer 24. The dummy substrate 12 is white, as described above, and thus the printability on the ink-receiving layer 24 can be significantly improved. The average roughness (Ra) of the surface 12a of the dummy substrate 12 is preferably as low as possible, and particularly preferably 0.1 μm or less. The surface roughness of 0.1 μm or less can be achieved by injection for forming the dummy substrate 12.

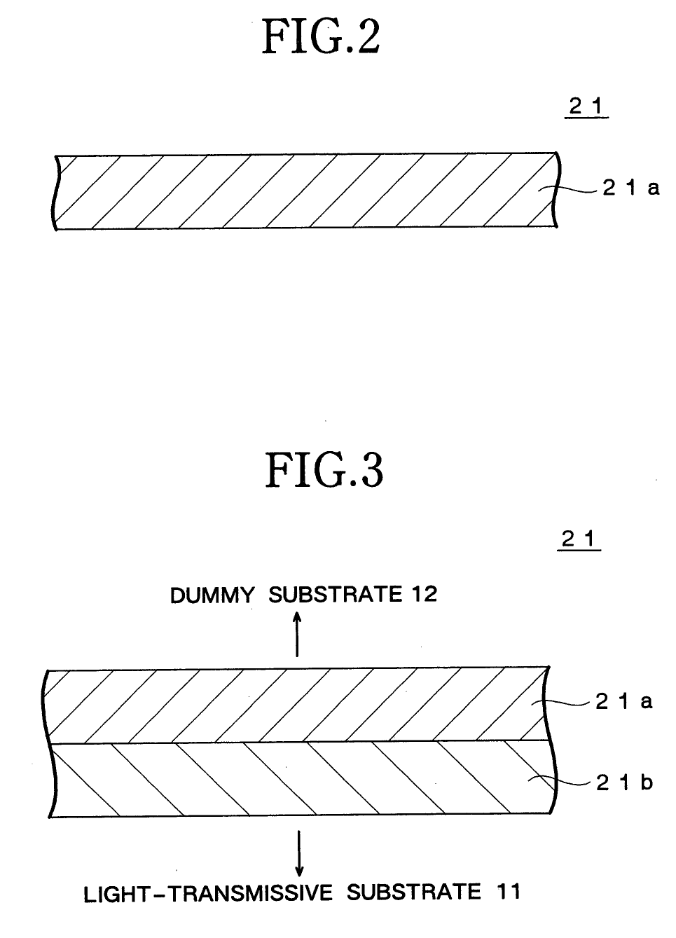

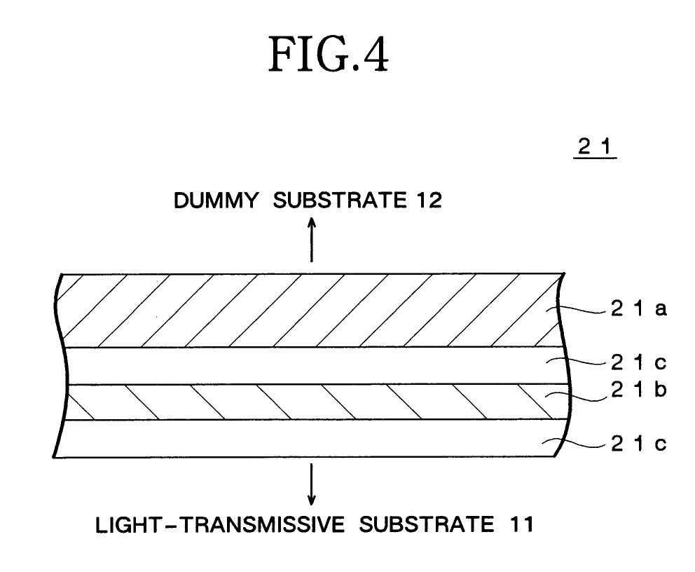

The structure and material of the functional layer 21 depend upon the type of disk used. In a ROM disk such as a DVD-ROM disk, the functional layer 21 generally comprises a reflective layer 21a containing a metal, as shown in FIG. 2. In a recordable disk such as a DVD-R disk, the functional layer 21 generally comprises a recording layer 21b containing an organic dye, and a reflective layer 21a containing a metal and provided on the recording layer 21b, as shown in FIG. 3. In a rewritable disk such as a DVD-RW disk, the functional layer 21 generally comprises a recording layer 21b containing a phase change material, a plurality of dielectric layers 21c holding the recording layer 21b therebetween, and a reflective layer 21a containing a metal, as shown in FIG. 4. However, the present invention is aimed at an optical recording medium permitting printing on a label surface, and thus the present invention is desirably applied to the recordable disk (FIG. 3) and the rewritable disk (FIG. 4).

The protective layer 22 is provided for protecting the functional layer 21 provided on the light-transmissive substrate 11. Although the material and thickness of the protective layer 22 are not particularly limited as long as the functional layer 21 can be physically and chemically protected, an acrylic or epoxy ultraviolet curable resin is preferably used as the material. The thickness of the protective layer 22 is set to, for example, 0.5 μm to 100 μm.

The adhesive layer 23 is a layer for bonding the laminate including the light-transmissive substrate 11, the functional layer 21, and the protective layer 22 to the dummy substrate 12. The thickness of the adhesive layer 23 is not particularly limited as long as the laminate and the dummy substrate 12 can be bonded together, and the thickness may be set to, for example, 10 μm to 200 μm.

The ink-receiving layer 24 constitutes the outermost layer opposite to the light incidence surface 11a. The ink-receiving layer 24 functions to receive and fix the ink supplied from an ink jet printer. In the present invention, it is necessary that the dummy substrate 12 can be seen through the ink-receiving layer 24, and thus the ink-receiving layer 24 is transparent. The smaller the average roughness (Ra) of the surface 24a of the ink-receiving layer 24, the more the print quality achieved by a printer, particularly a color and brilliance, is improved. In order to achieve a color and brilliance close to those of a silver salt photograph, i.e., photographic image quality, the average roughness (Ra) of the surface 24a of the ink-receiving layer 24 is preferably 0.1 μm or less. Although not particularly limited, the thickness of the ink-receiving layer 24 is preferably set to 10 μm to 30 μm. As a material for the ink-receiving layer 24, a material containing a hydrophilic resin such as polyvinyl alcohol or polyvinyl acetal as a main component, and a cationic polymer functioning as an ink fixing agent is preferably used.

The ink-receiving layer 24 is preferably formed by a spin coating method or a slit coating method. As is well known, the spin coating method comprises dropwisely applying a coating solution (prepared by diluting a material solution for the ink-receiving layer 24 in a solvent with water or another solvent) to the center of the surface (12a) of a treatment object (the dummy substrate 12) or the vicinity thereof, and rotating the treatment object to spread the coating solution in the peripheral direction by centrifugal force. On the other hand, the slit coating method comprises supplying a coating solution through a slit provided in a head, and relatively moving the head and a treatment object to spread the coating solution on the surface of the treatment object.

The reason for forming the ink-receiving layer 24 by the spin coating method or the slit coating method is that the average roughness (Ra) of the surface 24a can be decreased by the coating method. The spin coating method or slit coating method tends to increase the thickness distribution of the ink-receiving layer 24, as compared with a screen printing method. However, the ink-receiving layer 24 is transparent, and thus a small thickness distribution has substantially no influence on the print quality.

When the ink-receiving layer 24 is formed by the spin coating method or slit coating method, the surface quality of an underlying layer is greatly reflected in the ink-receiving layer 24, unlike in the screen printing method. Namely, the average roughness (Ra) of the underlying layer directly appears as the average roughness (Ra) of the surface 24a of the ink-receiving layer 24. In this embodiment, however, the dummy substrate 12, which can be formed by injection, is used as the underlying layer of the ink-receiving layer 24, and thus the average roughness (Ra) of the surface 12a can be easily decreased to 0.1 μm or less. Therefore, the average roughness (Ra) of the surface 24a of the ink-receiving layer 24 can also be decreased to 0.1 μm or less.

As described above, in this embodiment, the optical recording medium 10 comprises the dummy substrate 12 colored white and used as the underlying layer of the ink-receiving layer 24, thereby significantly decreasing the average roughness (Ra) of the surface 24a of the ink-receiving layer 24. Therefore, printing by an ink jet printer can achieve a color and brilliance close to those of a silver salt photograph.

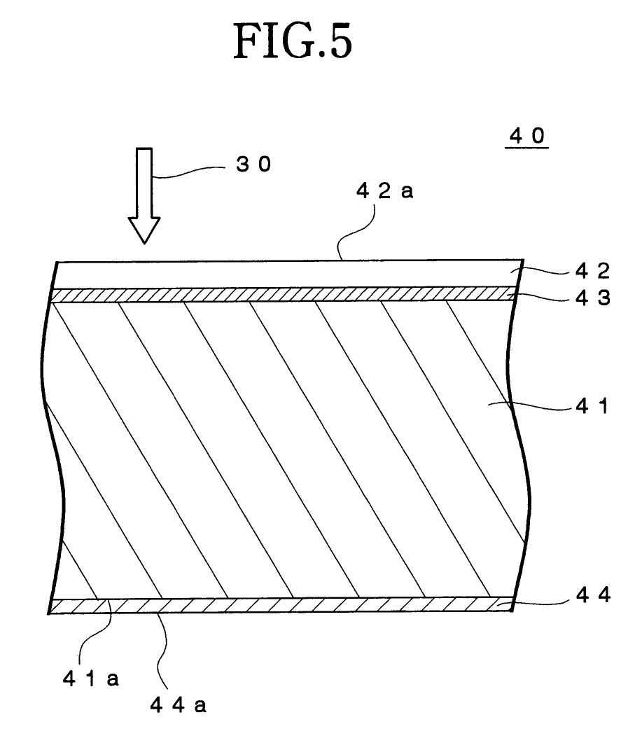

FIG. 5 is a sectional view schematically showing the structure of an optical recording medium according to another preferred embodiment of the present invention. In this embodiment, the present invention is applied to a next-generation optical recording medium.

An optical recording medium 40 of this embodiment is a disk-shaped optical recording medium having a diameter of about 120 mm and a thickness of about 1.2 mm. As shown in FIG. 5, the optical recording medium 40 comprises a support substrate 41, a light-transmissive layer 42, a functional layer 43 provided between the support substrate 41 and the light-transmissive layer 42, and an ink-receiving layer 44 provided on the surface 41a of the support substrate 41. Data recording and/or reproduction can be performed by applying a laser beam 30 to the light incidence surface 42a while rotating the optical recording medium 40. Although not particularly limited, the wavelength of the laser beam 30 is set to about 405 nm. The numerical aperture of an objective lens for converging the laser beam 30 is set to about 0.85.

The support substrate 41 functions to secure the mechanical strength of the optical recording medium 40. As described above, the support substrate 41 also includes the ink-receiving layer 44 provided on its surface 41a. Although not particularly limited, the thickness of the support substrate 41 is set to about 1.1 mm. As a material for the support substrate 41, the same material as descried above for the dummy substrate 12 is used. Like the dummy substrate 12, the support substrate 41 is colored white by adding a white pigment.

The light-transmissive layer 42 has the light incidence surface 42a and functions as the optical path of the laser beam 30. The thickness of the light-transmissive layer 42 is preferably set to 10 μm to 300 μm, and more preferably 50 μm to 150 μm. A material for the light-transmissive layer 42 is not particularly limited as long as it has sufficiently high transmittance in the wavelength region of the laser beam 30 used. However, an acrylic or epoxy ultraviolet curable resin is preferably used. Alternatively the light-transmissive layer 42 formed by using a light-transmissive sheet composed of a light-transmissive resin and a binder or an adhesive may be used instead of a film formed by curing an ultraviolet curable resin.

The structure and material of the functional layer 43 depend upon the type of disk used. Specifically, the functional layer 43 is similar to the functional layer 21 of the above-descried embodiment (refer to FIGS. 2 to 4).

The ink-receiving layer 44 is the outermost layer opposite to the light incidence surface 42a, and is exactly the same as the ink-receiving layer 24 of the above-described embodiment.

In this embodiment, the support substrate 41 for securing the mechanical strength of the optical recording medium 40 also functions as the underlying layer of the ink-receiving layer 44 and is colored white as described above, thereby significantly improving printability on the ink-receiving layer 44. Also, since the support substrate 41 can be formed by injection, the average roughness (Ra) of the surface 41a can easily be decreased to 0.1 μm or less. Consequently, the average roughness (Ra) of the surface 44a of the ink-receiving layer 44 can easily be decreased to 0.1 μm or less.

Therefore, the optical recording medium 40 of this embodiment comprises the support substrate 41 colored white and used as the underlying layer of the ink-receiving layer 44, and thus the average roughness (Ra) of the surface 44a of the ink-receiving layer 44 is significantly decreased. Therefore, printing by an ink jet printer can achieve a color and brilliance close to those of a silver salt photograph.

The present invention is not limited to the above-described embodiments, and various changes can be made in the scope of the claims of the present invention. Of course, these changes are also included in the scope of the present invention.

For example, in each of the embodiments, the support substrate (the dummy substrate 12 or the support substrate 41) is colored white by adding a white pigment to a transparent material such as a polycarbonate resin. However, the support substrate may be adjusted to a brightness of 8 or more and a chroma or 4 or less by using a white material for the support substrate instead of adding the white pigment to the transparent material.

Although, in each of the embodiments, the ink-receiving layer is formed directly on the surface of the support substrate (the dummy substrate 12 or the support substrate 41), another layer may be interposed between the support substrate and the ink-receiving layer as long as the surface quality of the support substrate is sufficiently reflected in the ink-receiving layer.

1. An optical recording medium comprising a support substrate, a functional layer for storing data, and a transparent ink-receiving layer opposite to the functional layer with respect to the support substrate, wherein the support substrate has a brightness of 8 or more, and a chroma of 4 or less.

2. The optical recording medium according to claim 1, wherein the support substrate has a brightness of 9 or more, and a chroma of 3 or less.

3. The optical recording medium according to claim 2, wherein the support substrate has a brightness of 9.2 or more, and a chroma of 0.5 or less.

4. The optical recording medium according to claim 1, wherein the ink-receiving layer has an average surface roughness (Ra) of 0.1 μm or less.

5. The optical recording medium according to claim 2, wherein the ink-receiving layer has an average surface roughness (Ra) of 0.1 μm or less.

6. The optical recording medium according to claim 3, wherein the ink-receiving layer has an average surface roughness (Ra) of 0.1 μm or less.

7. The optical recording medium according to claim 1, wherein the ink-receiving layer is formed on the surface of the support substrate.

8. The optical recording medium according to claim 4, wherein the ink-receiving layer is formed on the surface of the support substrate.

9. The optical recording medium according to claim 1, wherein the support substrate has an average surface roughness (Ra) of 0.1 μm or less.

10. The optical recording medium according to claim 4, wherein the support substrate has an average surface roughness (Ra) of 0.1 μm or less.

11. The optical recording medium according to claim 7, wherein the support substrate has an average surface roughness (Ra) of 0.1 μm or less.

12. The optical recording medium according to claim 8, wherein the support substrate has an average surface roughness (Ra) of 0.1 μm or less.

13. The optical recording medium according to claim 1, further comprising a light-transmissive substrate opposite to the support substrate with respect to the functional layer, the light-transmissive substrate having a thickness substantially the same as that of the support substrate.

14. The optical recording medium according to claim 1, further comprising a light-transmissive layer opposite to the support substrate with respect to the functional layer, the light-transmissive layer having a thickness smaller than that of the support substrate.

15. The optical recording medium according to claim 1, wherein the functional layer includes a recording layer.

16. The optical recording medium according to claim 15, wherein the recording layer contains an organic dye.

17. The optical recording medium according to claim 15, wherein the recording layer contains a phase change material.
